(19) United States
(12) Patent Application Publication
(10) Pub. No.: US 2026/0116388 A1
(43) Pub. Date: Apr. 30, 2026

(54) ELECTRICALLY OPERABLE FINAL DRIVE POWERTRAIN, METHOD FOR CONTROLLING A FINAL DRIVE POWERTRAIN, COMPUTER PROGRAM PRODUCT AND CONTROL UNIT FOR CONTROLLING A FINAL DRIVE POWERTRAIN

(71) Applicant: Schaeffler Technologies AG & Co. KG, Herzogenaurach (DE)

(72) Inventors: Simon Ortmann, Pulheim (DE); Benedikt Grubauer, Neresheim (DE)

(73) Assignee: Schaeffler Technologies AG & Co. KG, Herzogenaurach (DE)

(21) Appl. No.: 19/116,055

(22) PCT Filed: Aug. 29, 2023
(86) PCT No.: PCT/DE2023/100625

§ 371 Date: Mar. 27, 2025

(30) Foreign Application Priority Data
Sep. 28, 2022 (DE) 10 2022 124 955.7

(51) Int. Cl. B60W 30/182; B60K 7/00; B60K 17/02; B60K 17/04; B60L 7/24; B60T 1/06; B60W 10/02; B60W 10/08; B60W 10/184; B60W 10/196; F16D 65/78

(52) U.S. Cl. CPC B60W 30/182; B60K 7/0007; B60K 17/02; B60K 17/043; B60T 1/062; B60W 10/02; B60W 10/08; B60W 10/184; B60K 2007/0092; B60L 7/24; B60L 2260/24; B60L 2260/26; B60W 10/196; B60W 2710/021; B60W 2710/08; B60W 2710/18; F16D 65/78

(57) ABSTRACT

The invention relates to an electrically operable final drive powertrain (1) of a motor vehicle, comprising an electric machine (3) which can be coupled to: at least one vehicle wheel (4) of the motor vehicle; and a transmission assembly (5) arranged in the torque flow between the vehicle w heel (4) and the electric machine (3); and a brake device (6) by means of which the vehicle wheel (4) can be braked; wherein: in the torque flow between the electric machine (3) and the brake device (6), a first clutch device (7) is arranged, by means of which the brake device (6) can be coupled into and coupled out of the torque flow, and,
in the torque flow between the electric machine (3) and the transmission assembly (5), a second clutch device (8) is arranged, by means of which the transmission assembly (5) can be coupled into and coupled out of the torque flow; or, in the torque flow between the electric machine (3) and the brake device (6), a first clutchdevice (7) is arranged, by means of which the brake device (6) can be coupled into and coupled out of the torque flow, and,
in the torque flow between the brake device (6) and the transmission assembly (5), a second clutch device (8) is arranged, by means of which the transmission assembly (5) can be coupled into and coupled out of the torque flow.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2023/100625, filed on Aug. 29, 2023, designating the United States of America, which in turn claims the benefit of priority under 35 U.S.C. §§ 119, 365 of German Patent Application No. 10 2022 124 955.7 filed on Sep. 28, 2022, the contents of which are relied upon and incorporated herein by reference in their entirety.

### FIELD OF THE DISCLOSURE

The present disclosure relates to an electrically operable final drive powertrain of a motor vehicle, comprising an electric machine which can be coupled to at least one vehicle wheel of the motor vehicle in a torque-transmitting manner, and a transmission assembly arranged in the torque flow between the vehicle wheel and the electric machine, as well as a brake device, by means of which the vehicle wheel can be braked. The disclosure further relates to a method for controlling a final drive powertrain, a computer program product and a control unit for controlling a final drive powertrain.

### BACKGROUND OF THE DISCLOSURE

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to.

### SUMMARY OF THE DISCLOSURE

It is an object of the disclosure to provide an electrically operable final drive powertrain of a motor vehicle which realizes a large number of different selectable operating modes. It is also an object of the disclosure to provide a method for controlling a final drive powertrain, a computer program product for controlling a final drive powertrain and a control unit for controlling a final drive powertrain.

An electrically operable final drive powertrain of a motor vehicle, includes an electric machine which can be coupled to at least one vehicle wheel of the motor vehicle in a torque-transmitting manner, and a transmission assembly arranged in the torque flow between the vehicle wheel and the electric machine, as well as a brake device, by means of which the vehicle wheel can be braked, and
a) a first clutch device is arranged in the torque flow between the electric machine and the brake device, by means of which first clutch device the brake device can be coupled into and decoupled from the torque flow, and a second clutch device is arranged in the torque flow between the electric machine and the transmission assembly, by means of which second clutch device the transmission assembly can be coupled into and decoupled from the torque flow, or
b) a first clutch device is arranged in the torque flow between the electric machine and the brake device, by means of which first clutch device the brake device can be coupled into and decoupled from the torque flow, and a second clutch device is arranged in the torque flow between the brake device and the transmission assembly, by means of which second clutch device the transmission assembly can be coupled into and decoupled from the torque flow.

This has the advantage that a large number of different operating modes can be realized, which is explained in more detail below.

The advantage of the embodiment designated a) is that the rotatable part of the brake device can be deactivated during driving so that it does not generate any drag torque and particularly efficient driving can be achieved.

In the design alternative of the final drive powertrain designated b), a fully integrated variant is realized, which also has shiftable clutch devices. The arrangement of the clutch devices realized in variant b) makes it possible, for example, to completely decouple the electric machine from the powertrain when simply braking the vehicle wheel with the brake device.

An electrically operable powertrain comprises an electric machine and may include a transmission assembly coupled to the electric machine. The transmission assembly and the electric machine form a structural unit. This can be formed, for example, by means of a powertrain housing, in which the transmission assembly and the electric machine are accommodated together. This structural unit is sometimes also referred to as an e-axle.

The electric machine is used to convert electrical energy into mechanical energy and/or vice versa, and generally comprises a stationary part, referred to as a stator, and a part referred to as a rotor, which is arranged movably, in particular rotatably, in relation to the stationary part. The electric machine can be configured as a radial flux machine or an axial flux machine.

In particular, the electric machine is dimensioned such that vehicle speeds of more than 50 km/h, more than 80 km/h, and/or more than 100 km/h can be achieved. The electric motor particularly preferably has an output of more than 30 kW, more than 50 kW, and/or more than 70 KW. Furthermore, the electric machine may provide speeds greater than 5000 rpm, greater than 10,000 rpm, and/or greater than 12,500 rpm.

The powertrain may further comprise a control unit. A control unit, as used in the present disclosure, may serve for electronic open- and/or closed-loop control of one or more technical systems of a powertrain, such as the electric machine and/or the clutch and/or the brake devices.

The control unit may have a wired or wireless signal input for receiving electrical signals, such as sensor signals, for example. Furthermore, the control unit likewise may have a wired or wireless signal output for the transmission of, electrical signals, for example to electrical actuators or electrical consumers of the electrically operable final drive powertrain or of the motor vehicle.

Open-loop control operations and/or closed-loop control operations can be carried out within the control unit. The control unit may comprise hardware that is designed to run software. The control unit may comprise at least one electronic processor for executing program sequences defined in software.

The control unit can also have one or more electronic memories in which the data contained in the signals transmitted to the control unit can be stored and read out again. Furthermore, the control unit can have one or more electronic memories in which data can be stored in a modifiable and/or non-modifiable manner.

The control unit can comprise a plurality of controllers which are arranged in particular spatially separate from one another in the motor vehicle. Controllers are also referred to as electronic control units (ECU) or electronic control modules (ECM) and can have electronic microcontrollers for carrying out computing operations for processing data using software. The controllers can be interconnected with one another such that a wired and/or wireless data exchange between controllers is made possible. The controllers can be interconnected with one another via bus systems present in the motor vehicle, such as a CAN bus or LIN bus, for example.

In some embodiments, the control unit has at least one processor and at least one memory, which contains a computer program code, the memory and the computer program code being configured to cause the control unit to execute the computer program code with the processor.

The control unit can comprise a power electronics module for supplying power to the electric machine. A power electronics module can be a combination of different components that provide open- or closed-loop control of a current to the electric machine, including the peripheral components required for this purpose, such as cooling elements or power supply units. In particular, the power electronics module contains a power electronics system or one or more power electronics components that are configured to provide open- or closed-loop control of a current. These can be one or more power switches, such as power transistors. The power electronics system particularly preferably has more than two phases or current paths which are separate from one another and which each have at least one separate power electronics component. The power electronics system can be designed for the open-loop or closed-loop control of a power per phase with a peak power, such as a continuous power, of at least 100 W, at least 1000 W, and/or at least 10000 W.

A clutch device can be a manual, semi-automatic or automatic clutch device. In some embodiments, a clutch device can be a separating clutch. The clutch device can be an e-clutch. An e-clutch is an automated clutch device that is electrically controlled and actuated. The clutch device can also be a double clutch or a multi-plate clutch. Furthermore, it is possible to design the clutch device to be frictional and/or interlocking. According to an aspect of the disclosure, the clutch device can be actuated by means of a hydraulic disengagement system. A hydraulic disengagement system can have a master cylinder that transmits the pressure generated on the master cylinder to the slave cylinder, such as a central release mechanism, via a hydraulic pressure line. The hydraulic pressure can also be provided by means of what is known as a power pack, which consists of a hydraulic pump and a hydraulic pressure accumulator that can be acted upon by the hydraulic pump. In this case, a pressure chamber of the slave cylinder can also be pressurized hydraulically, for example by a master cylinder that is controlled by means of an electric motor of a controller or by a hydraulic pump, optionally with the cooperation of a pressure accumulator. A power pack can be used in an advantageous manner, which switches a plurality of pressure circuits, via a central hydraulic pump and corresponding valves.

The slave cylinder, which in various embodiments is designed as a central release mechanism, transmits the hydraulic pressure to a clutch device in the hydraulic disengagement system by means of an axially displaceable piston, for example in order to form a frictional connection and to close the friction clutch or to open it when the frictional connection is released.

The hydraulic clutch disengagement system can actuate a clutch device hydraulically by the action of the master cylinder. This can be done—as explained—either by means of an actuator that is controlled by a control unit or by manual actuation by the driver.

According to an embodiment of the disclosure, the brake device is encapsulated in a housing. Abrasion from the brake device cannot enter the environment through the encapsulated housing, thus avoiding environmental and health impacts caused by brake abrasion during operation of the final drive powertrain.

According to the disclosure, the brake device, the transmission assembly, the electric machine, the first clutch device and the second clutch device can form a structural unit. This makes it possible to provide a pre-assembled functional module which can then be integrated into a vehicle with comparatively little installation effort.

Furthermore, according to an embodiment of the disclosure, it is possible for the final drive powertrain to have a control unit which is connected to the brake device, the first clutch device and the second clutch device and which is configured such that the control unit can transfer the final drive powertrain into a plurality of different operating states by coupling and decoupling the clutch devices and by releasing and actuating the brake device. The advantageous effect of this embodiment is based on the fact that the various operating modes that the final drive powertrain allows due to its architecture can be provided by the electronic open-loop control system.

According to a further embodiment of the disclosure, it is possible for the control unit to be configured in such a way that, for design alternative a) of the final drive powertrain, it transfers said final drive powertrain
i. into a first operating state in which the first clutch device and the second clutch device are in a decoupled state and the brake device is released, and/or
ii. into a second operating state in which the first clutch device is in a decoupled state and the second clutch device is in a coupled state and the brake device is released, and/or
iii. into a third operating state in which the first clutch device and the second clutch device are in a coupled state and the brake device is actuated, and/or
iv. into a fourth operating state in which the first clutch device is in a decoupled state and the second clutch device is in a coupled state and the brake device is actuated,
   or
   the control unit is configured in such a way that for design alternative b) of the final drive powertrain, it transfers said final drive powertrain
i. into a first operating state in which the first clutch device and the second clutch device are in a decoupled state and the brake device is released, and/or
ii. into a second operating state in which the first clutch device and the second clutch device are in a coupled state and the brake device is released, and/or
iii. into a third operating state in which the first clutch device and the second clutch device are in a coupled state and the brake device is actuated, and/or
iv. into a fourth operating state in which the first clutch device is in a decoupled state and the second clutch device is in a coupled state and the brake device is actuated, and/or
v. into a fifth operating state in which the first clutch device is in a coupled state and the second clutch device is in a decoupled state and the brake device is actuated.

In the first operating states (i) of design alternatives a) and b), the final drive powertrain is transferred into what is known as a coasting mode, in which the electric machine is decoupled from the vehicle wheel in order to avoid corresponding resistances generated by the electric machine.

A coasting process of the vehicle means a driving state of the vehicle in which a vehicle wheel is at least decoupled from the electric machine of the powertrain by opening the corresponding clutch device or clutch devices, whereby the lost torque of the electric machine and possibly the brake device are decoupled from the vehicle wheel and the energy efficiency of the motor vehicle can thus be increased and energy consumption reduced. During the coasting process, the electric machine can be switched off or in operation. A coasting process can thus, for example, cause a reduction in the speed of the motor vehicle without actively braking a vehicle wheel, for example by the air and rolling resistance of the motor vehicle.

In the second operating state (ii) of first design alternative a) and of second embodiment b), a ‘standard’ driving mode can be set in which the electric machine drives the vehicle wheel in motor mode and/or brakes it in generator mode (regenerative braking).

In the third operating state (iii) of first embodiment a) and of second embodiment b), the brake device is coupled to the vehicle wheel so that a ‘mechanical’ braking of the vehicle wheel is realized. The electric machine can be transferred into generator mode and thus support the braking effect of the mechanical brake device. In this third operating state, the electric machine can also be transferred into a motor mode, for example in order to realize a thermal heating and/or cooling circuit in the vehicle during driving via increased frictional heat of the brake device, in particular for climate control of the passenger compartment.

In the fourth operating state (iv) of first embodiment a) and of the second embodiment, for example when the vehicle is at a standstill, an auxiliary heating function can be realized with which the electric machine drives the brake device in motor mode, generating corresponding frictional heat. This frictional heat can then be used, for example, via a thermal heating and/or cooling circuit in the vehicle, in particular for climate control of the passenger compartment.

It is understood that the final drive powertrain can be transferred to one and/or more of these operating states.

Furthermore, in the third operating state of the final drive powertrain, the electric machine is in a torque-generating operating state in order to realize some of the above operating modes, such as an auxiliary heating function when the vehicle is at a standstill.

In an embodiment of the disclosure, it is also possible for the brake device to be connected to a fluid circuit by means of which heat generated by the brake device during operation of the final drive powertrain can be dissipated. This makes it possible to simplify the thermal management system within the vehicle, for example by eliminating a PTC heating element.

An object of the disclosure is achieved by a method for controlling a final drive powertrain of a motor vehicle, comprising an electric machine which can be coupled to at least one vehicle wheel of the motor vehicle in a torque-transmitting manner, and a transmission assembly arranged in the torque flow between the vehicle wheel and the electric machine, as well as a brake device by means of which the vehicle wheel can be braked,
a) a first clutch device being arranged in the torque flow between the electric machine and the brake device, by means of which first clutch device the brake device can be coupled into and decoupled from the torque flow, and a second clutch device being arranged in the torque flow between the electric machine and the transmission assembly, by means of which second clutch device the transmission assembly can be coupled into and decoupled from the torque flow,
   or
b) a first clutch device being arranged in the torque flow between the electric machine and the brake device, by means of which first clutch device the brake device can be coupled into and decoupled from the torque flow, and a second clutch device being arranged in the torque flow between the brake device and the transmission assembly, by means of which second clutch device the transmission assembly can be coupled into and decoupled from the torque flow,
and the final drive powertrain comprises a control unit which is connected to the brake device, the first clutch device and the second clutch device and is configured such that the control unit can transfer the final drive powertrain into a plurality of different operating states by coupling and decoupling the clutch devices and by releasing and actuating the brake device,
and the control unit is configured such that for design alternative a of the final drive powertrain it transfers said final drive powertrain
   i. into a first operating state in which the first clutch device and the second clutch device are in a decoupled state and the brake device is released, and/or
   ii. into a second operating state in which the first clutch device is in a decoupled state and the second clutch device is in a coupled state and the brake device is released, and/or
   iii. into a third operating state in which the first clutch device and the second clutch device are in a coupled state and the brake device is actuated, and/or
   iv. into a fourth operating state in which the first clutch device is in a decoupled state and the second clutch device is in a coupled state and the brake device is actuated,
or
   i. the control unit is configured in such a way that for design alternative b of the final drive powertrain it transfers said final drive powertrain
   ii. into a first operating state in which the first clutch device and the second clutch device are in a decoupled state and the brake device is released, and/or
   iii. into a second operating state in which the first clutch device and the second clutch device are in a coupled state and the brake device is released, and/or
   iv. into a third operating state in which the first clutch device and the second clutch device are in a coupled state and the brake device is actuated, and/or
   v. into a fourth operating state in which the first clutch device is in a decoupled state and the second clutch device is in a coupled state and the brake device is actuated, and/or
   vi. into a fifth operating state in which the first clutch device is in a coupled state and the second clutch device is in a decoupled state and the brake device is actuated.

An object of the disclosure may be achieved by a computer program product stored on a machine-readable carrier, or a computer data signal embodied by an electromagnetic wave, having a computer program code suitable for carrying out a method.

An object of the disclosure may be achieved by a control unit for controlling a final drive powertrain of a motor vehicle, the control unit comprising a processor and a memory containing a computer program code, wherein the memory and the computer program code are configured, with the processor, to cause the control unit to carry out a method.

The disclosure is explained in more detail below with reference to figures without limiting the general concept of the disclosure.

### BRIEF DESCRIPTION OF THE DRAWINGS

In the drawings:

FIG. 1 shows a first embodiment of a final drive powertrain in a first operating state in a schematic block diagram;

FIG. 2 shows a first embodiment of a final drive powertrain in a second operating state in a schematic block diagram;

FIG. 3 shows a first embodiment of a final drive powertrain in a third operating state in a schematic block diagram;

FIG. 4 shows a first embodiment of a final drive powertrain in a fourth operating state in a schematic block diagram;

FIG. 5 shows a second embodiment of a final drive powertrain in a first operating state in a schematic block diagram;

FIG. 6 shows a second embodiment of a final drive powertrain in a second operating state in a schematic block diagram;

FIG. 7 shows a second embodiment of a final drive powertrain in a third operating state in a schematic block diagram;

FIG. 8 shows a second embodiment of a final drive powertrain in a fourth operating state in a schematic block diagram; and

FIG. 9 shows a second embodiment of a final drive powertrain in a fifth operating state in a schematic block diagram.

### DETAILED DESCRIPTION

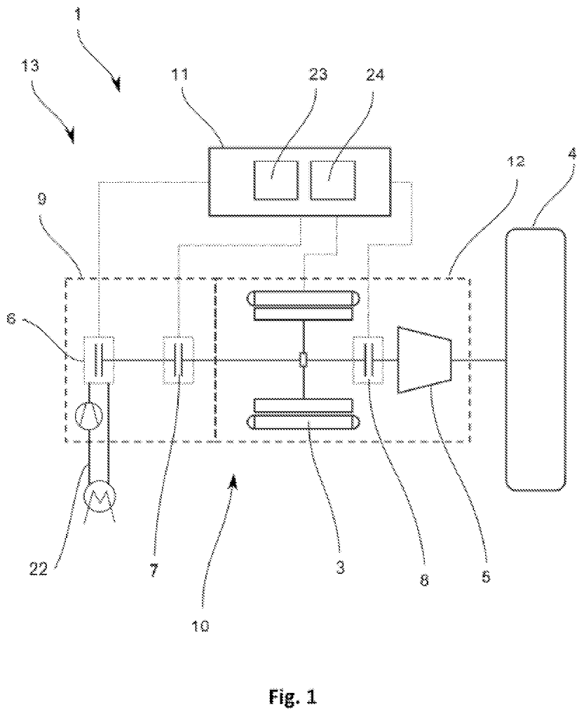

FIGS. 1-9 show an electrically operable final drive powertrain 1 of a motor vehicle, comprising an electric machine 3, which can be coupled to at least one vehicle wheel 4 of the motor vehicle in a torque-transmitting manner, and a transmission assembly 5 arranged in the torque flow between the vehicle wheel 4 and the electric machine 3, as well as a brake device 6, by means of which the vehicle wheel 4 can be braked.

In the first embodiment of the final drive powertrain 1 (design alternative a)), which is shown in different operating states in FIGS. 1-4, a first clutch device 7 is arranged in the torque flow between the electric machine 3 and the brake device 6, by means of which first clutch device the brake device 6 can be coupled into and decoupled from the torque flow. In addition, a second clutch device 8 is also arranged in the torque flow between the electric machine 3 and the transmission assembly 5, by means of which clutch device the transmission assembly 5 can be coupled into and decoupled from the torque flow.

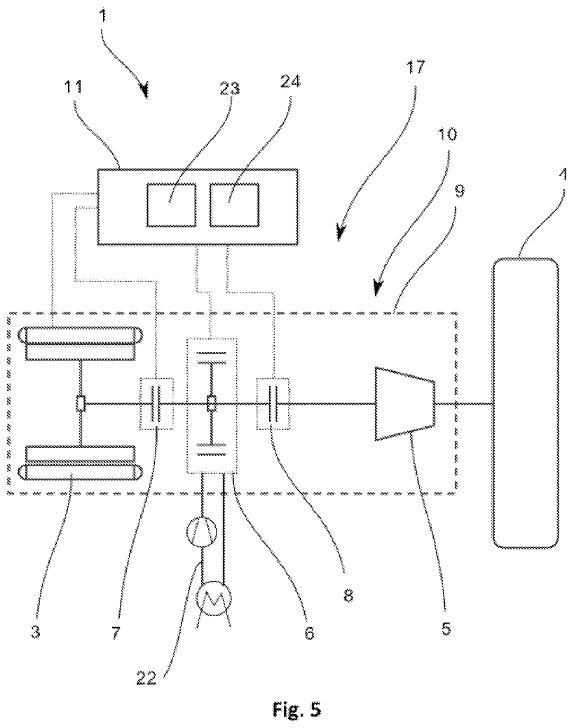

In the second embodiment of the final drive powertrain 1 (design alternative b)), which is shown in different operating states in FIGS. 5-9, a first clutch device 7 is arranged in the torque flow between the electric machine 3 and the brake device 6, by means of which first clutch device the brake device 6 can be coupled into and decoupled from the torque flow, and furthermore a second clutch device 8 is arranged in the torque flow between the brake device 6 and the transmission assembly 5, by means of which second clutch device the transmission assembly 5 can be coupled into and decoupled from the torque flow.

From FIGS. 1-9 it is also apparent that the brake device 6 in both embodiments is encapsulated in a housing 9. In the first embodiment of FIGS. 1-4, the brake device 6 is accommodated in a separate housing 9 which is associated with the brake device 6 and which can be connected, for example, to the motor housing 12 of the electric machine 3. In the second embodiment of FIGS. 5-9, the housing 9 encloses the electric machine 3, the transmission assembly 5 and the brake device 6. It is understood that the brake device 6 can also have a separate housing for encapsulation in this embodiment, but this is not shown in the figures.

In the embodiments shown in FIGS. 1-9, the brake device 6, the transmission assembly 5, the electric machine 3, the first clutch device 7 and the second clutch device 8 form a structural unit 10 and can thus be supplied as a module and mounted on the vehicle.

In the embodiments shown, the brake device 6 is connected to a fluid circuit 22, by means of which heat generated by the brake device 6 during operation of the final drive powertrain 1 can be dissipated, for example in order to cool the brake device 6 and/or to use the dissipated heat for climate control of the passenger compartment of the vehicle.

In both embodiments, the final drive powertrain 1 has a control unit 11 which is connected to the brake device 6, the first clutch device 7 and the second clutch device 8 and is configured such that the control unit 11 can transfer the final drive powertrain 1 into a plurality of different operating states by coupling and decoupling the clutch devices 7, 8 and by releasing and actuating the brake device 6. The control unit 11 comprises a processor 23 and a memory 24 containing a computer program code, and the memory 24 and the computer program code are configured, with the processor 23, to cause the control unit 11 to carry out a method which sets the different operating states described below.

FIG. 1 shows a first operating state 13 into which the control unit 11 has transferred the final drive powertrain 1 for design alternative a). In this first operating state 13, the first clutch device 7 and the second clutch device 8 are in a decoupled state. The brake device 6 is released so that a coasting mode of the final drive powertrain 1 can be realized.

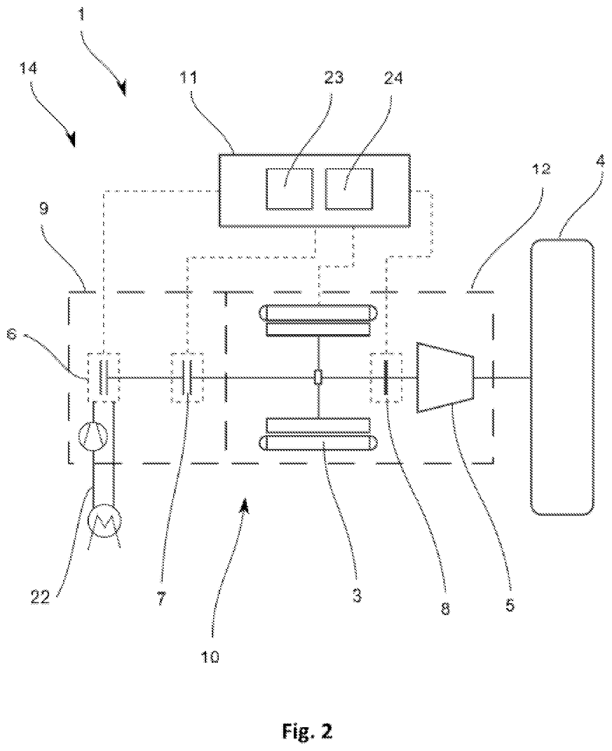

In FIG. 2, the final drive powertrain known from FIG. 1 is transferred to a second operating state 14 in which the first clutch device 7 is in a decoupled state and the second clutch device 8 is in a coupled state and the brake device 6 is still released, such that regular driving or regenerative braking can be brought about, depending on whether the electric machine 3 is in a motor or generator operating state.

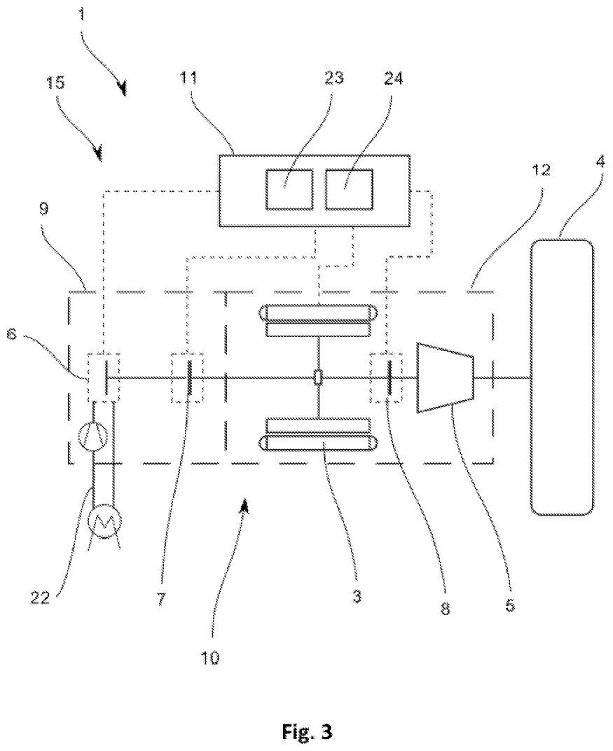

In a third operating state 15, which is shown in FIG. 3, the first clutch device 7 and the second clutch device 8 are in a coupled state. Furthermore, the brake device 6 is actuated so that the brake device 6 is coupled to the vehicle wheel 4 and a “mechanical” braking of the vehicle wheel is realized. The electric machine 3 can be transferred into generator mode and thus support the braking effect of the mechanical brake device 6. In this third operating state 15, the electric machine 3 can also be transferred to a motor mode, for example in order to realize a thermal heating and/or cooling circuit (fluid circuit 22) in the vehicle, in particular for climate control of the passenger compartment, during driving via increased frictional heat of the brake device 6.

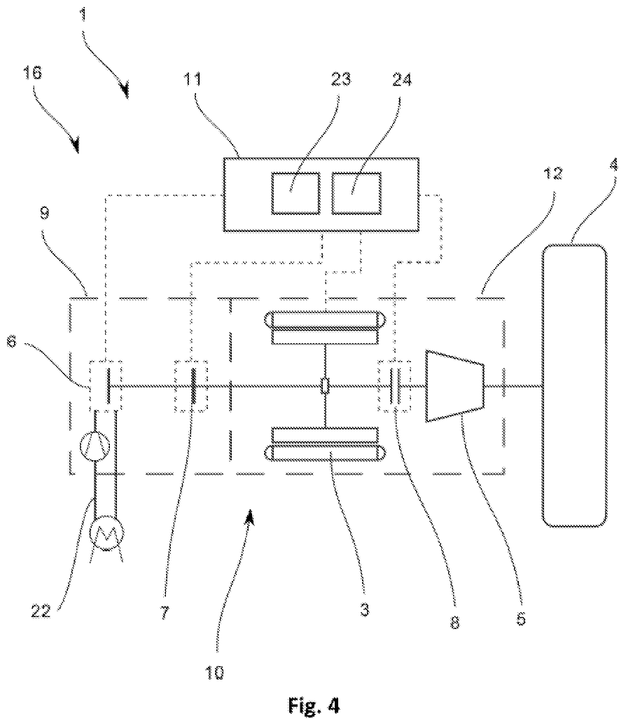

In FIG. 4, the final drive powertrain 1 is transferred into a fourth operating state 16 in which the first clutch device 7 is in a decoupled state and the second clutch device 8 is in a coupled state and the brake device 6 is actuated. In the fourth operating state 16 of the first embodiment, for example, when the vehicle is at a standstill, a parking heater function can be realized, in which the electric machine 3 drives the brake device 6 in motor mode, generating corresponding frictional heat. This frictional heat can then be used, for example, via a thermal heating and/or cooling circuit (fluid circuit 22) in the vehicle, in particular for climate control of the passenger compartment.

FIG. 5 shows a first operating state 17 into which the control unit 11 has transferred the final drive powertrain 1 for design alternative b). In this first operating state 17, the first clutch device 7 and the second clutch device 8 are in a decoupled state and the brake device 6 is released. This enables a coasting mode of the final drive powertrain 1.

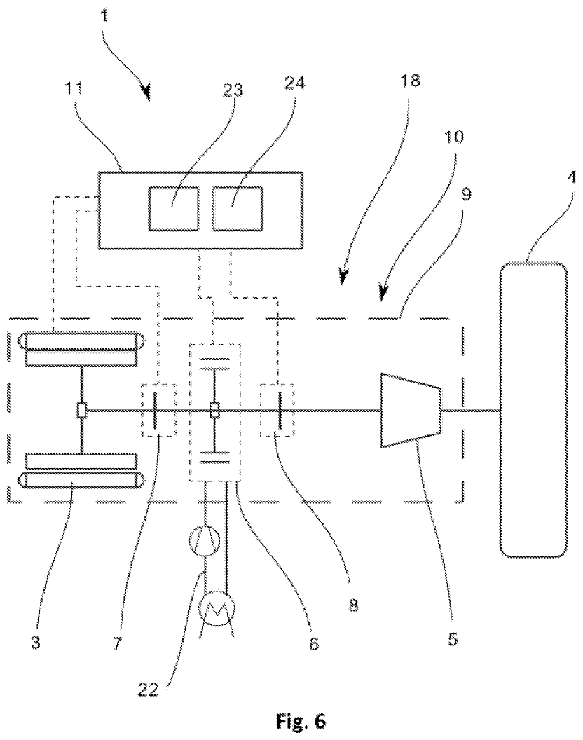

In FIG. 6, the final drive powertrain from FIG. 5 is transferred to a second operating state 18 in which the first clutch device 7 and the second clutch device 8 are in a coupled state and the brake device 6 is released. This enables regular driving or regenerative braking to be achieved, depending on whether the electric machine 3 is in a motor or generator operating state.

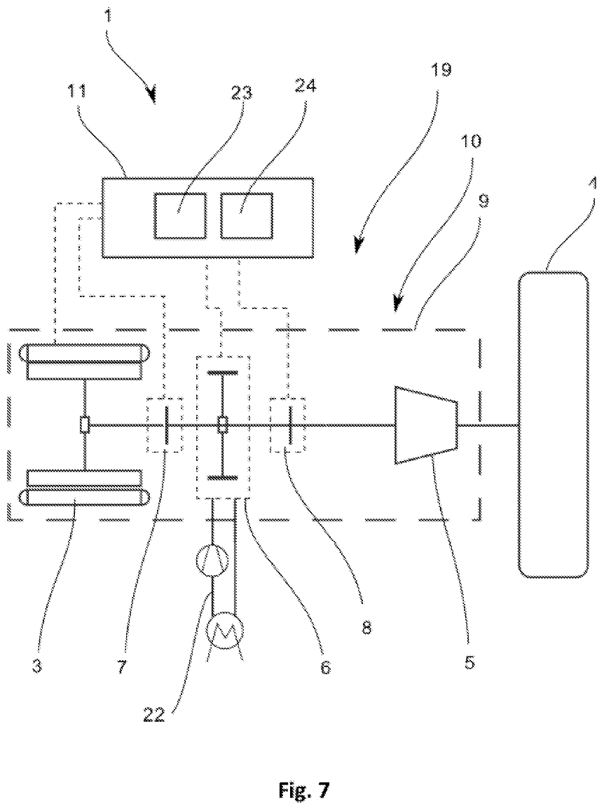

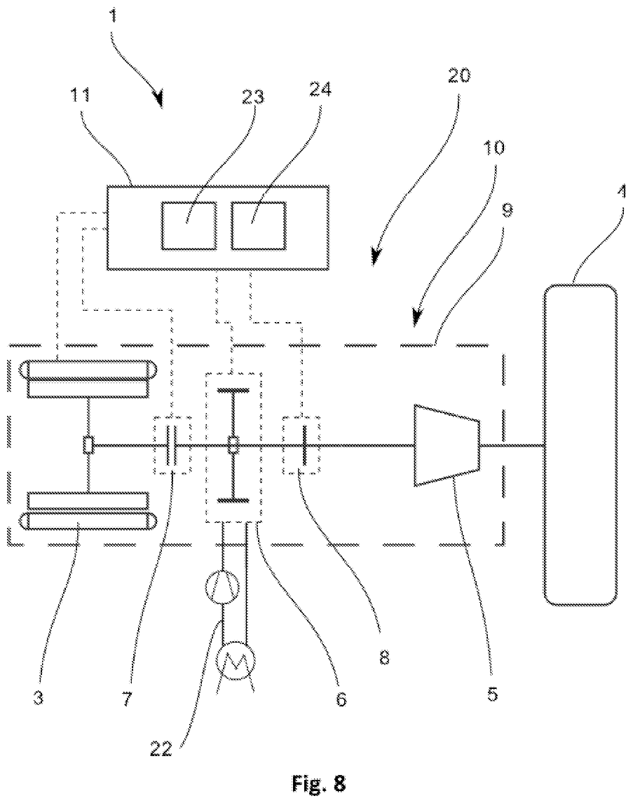

In a third operating state 19, which is shown in FIG. 7, the first clutch device 7 and the second clutch device 8 are in a coupled state and the brake device 6 is actuated, such that the brake device 6 is coupled to the vehicle wheel 4 and ‘mechanical’ braking of the vehicle wheel 4 is realized. The electric machine 3 can be transferred into generator mode and thus support the braking effect of the mechanical brake device 6. In this third operating state 15, the electric machine 3 can also be transferred to a motor mode, for example in order to realize a thermal heating and/or cooling circuit (fluid circuit 22) in the vehicle, in particular for climate control of the passenger compartment, during driving via increased frictional heat of the brake device 6. In FIG. 8, the final drive powertrain 1 has been placed in a fourth operating state 20, in which the first clutch device 7 is in a decoupled state and the second clutch device 8 is in a coupled state and the brake device 6 is actuated, such that the vehicle wheel 4 can be braked solely by the brake device 6, without the brake device 6 additionally being subjected to a drag torque of the electric machine 3.

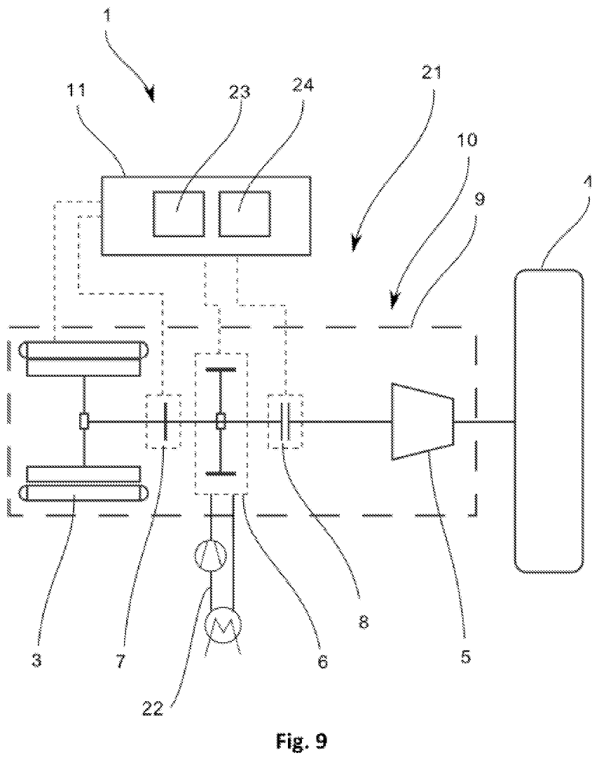

The second embodiment of the final drive powertrain 1 can also be transferred to a fifth operating state 21, which is shown in FIG. 9 and in which the first clutch device 7 is in a coupled state and the second clutch device 8 is in a decoupled state and the brake device 6 is actuated. In the fifth operating state 21 of the second embodiment, for example, when the vehicle is at a standstill, a parking heater function can be realized in which the electric machine 3 drives the brake device 6 in motor mode, generating corresponding frictional heat. This frictional heat can then be used, for example, via a thermal heating and/or cooling circuit (fluid circuit 22) in the vehicle, in particular for climate control of the passenger compartment.

The terms “radial”, “axial”, “tangential” and “circumferential direction” used in this application always refer to the axis of rotation of a rotor of the electric machine. The terms “left”, “right”, “above”, “below”, “over” and “under” are used here only to clarify which regions of the illustrations are currently being described in the text. The disclosure is also not limited to the embodiments shown in the figures. The above description is therefore not to be regarded as limiting, but rather as illustrative. The following claims are to be understood as meaning that a stated feature is present. This does not exclude the presence of further features. Where the claims and the above description define ‘first’ and ‘second’ features, this designation serves to distinguish between two features without defining an order of precedence.

### LIST OF REFERENCE SIGNS

1 Final drive powertrain
3 Electric machine
4 Vehicle wheel
5 Transmission assembly
6 Brake device
7 Clutch device
8 Clutch device
9 Housing
10 Unit
11 Control unit
12 Motor housing
13 Operating state
14 Operating state
15 Operating state
16 Operating state
17 Operating state
18 Operating state
19 Operating state
20 Operating state
21 Operating state
22 Fluid circuit
23 Processor
24 Memory

1. An electrically operable final drive powertrain of a motor vehicle, comprising:
an electric machine which can be coupled to at least one vehicle wheel of the motor vehicle in a torque-transmitting manner;
a transmission assembly arranged in the torque flow between the vehicle wheel and the electric machine;
a brake via which the vehicle wheel can be braked;
a first clutch arranged in the torque flow between the electric machine and the brake and operable to couple and decouple the brake from the torque flow; and
a second clutch arranged in the torque flow between (1) the electric machine and the transmission assembly or (2) the brake and the transmission assembly, the second clutch being operable to couple and decouple the transmission assembly from the torque flow.

2. The final drive powertrain of claim 1, wherein
the brake is encapsulated in a housing.

3. The final drive powertrain of claim 1, wherein
the brake, the transmission assembly, the electric machine, the first clutch, and the second clutch form a structural unit.

4. The final drive powertrain of claim 1, further comprising:
a control unit connected to the brake, the first clutch, and the second clutch, and
operable to transfer the final drive powertrain into a plurality of different operating states by controlling the first clutch, the second clutch, and the brake.

5. The final drive powertrain of claim 4, wherein the second clutch is arranged in the torque flow between the electric machine and the transmission assembly, and the plurality of different operating states includes:
a first operating state in which the first clutch is in a decoupled state, the second clutch is in a decoupled state, and the brake is released;
a second operating state in which the first clutch is in the decoupled state, the second clutch is in a coupled state, and the brake is released;
a third operating state in which the first clutch is in a coupled state, the second clutch is in the coupled state, and the brake is actuated; and
a fourth operating state in which the first clutch is in the decoupled state, the second clutch is in a coupled state, and the brake is actuated.

6. The final drive powertrain of claim 5,
wherein in the third operating state of said final drive powertrain the electric machine is in a torque-generating operating state.

7. The final drive powertrain of claim 1, wherein
the brake device is connected to a fluid circuit via which heat generated by the brake during operation of said final drive powertrain can be dissipated.

8. A method for controlling a final drive powertrain of a motor vehicle that includes an electric machine which can be coupled to a vehicle wheel of the motor vehicle in a torque-transmitting manner, a transmission assembly arranged in the torque flow between the vehicle wheel and the electric machine, a brake for braking the vehicle wheel, a first clutch arranged in the torque flow between the electric machine and the brake via which the brake can coupled and decoupled from the torque flow, and a second clutch arranged in the torque flow between (1) the electric machine and the transmission assembly or (2) the brake and the transmission assembly, the second clutch being operable to couple and decouple the transmission assembly from the torque flow, comprising the steps of:
entering a first operating state, wherein the first clutch is in a decoupled state, the second clutch is in a decoupled state, and the brake is released;
entering a second operating state, wherein the second clutch is coupled and the brake is released;
entering a third operating state, wherein the first clutch is in a coupled state, the second clutch is in the coupled state, and the brake is actuated; and
entering a fourth operating state, wherein the first clutch is in the decoupled state, the second clutch is in a coupled state, and the brake is actuated.

9. (canceled)

10. (canceled)

11. The method of claim 8, wherein the second clutch is arranged in the torque flow between the electric machine and the transmission assembly, and wherein the first clutch is in a decoupled state in the second operating state.

12. The method of claim 8, wherein the second clutch is arranged in the torque flow between the brake and the transmission assembly, and wherein the first clutch is in a coupled state in the second operating state.

13. The method of claim 12, further comprising the step of:
entering a fifth operating state, wherein the first clutch is in a coupled state, the second clutch is in a decoupled state, and the brake is actuated.

14. The final drive powertrain of claim 4, wherein the second clutch is arranged in the torque flow between the brake and the transmission assembly, and the plurality of different operating states includes:
a first operating state in which the first clutch is in a decoupled state, the second clutch is in a decoupled state, and the brake is released;
a second operating state in which the first clutch is in a coupled state, the second clutch is in a coupled state, and the brake is released;
a third operating state in which the first clutch is in the coupled state, the second clutch is in the coupled state, and the brake is actuated;
a fourth operating state in which the first clutch is in the decoupled state, the second clutch is in a coupled state, and the brake is actuated; and
a fifth operating state in which the first clutch is in the coupled state, the second clutch is in a decoupled state, and the brake is actuated.

15. An electrically operable drive powertrain for a motor vehicle, comprising:
an electric machine which can be coupled to at least one vehicle wheel of the motor vehicle in a torque-transmitting manner;
a transmission assembly arranged in the torque flow between the vehicle wheel and the electric machine;
a brake via which the vehicle wheel can be braked;
a first clutch arranged in the torque flow between the electric machine and the brake and operable to couple and decouple the brake from the torque flow; and
a second clutch operable to couple and decouple the transmission assembly from the torque flow.

16. The drive powertrain of claim 15, wherein the second clutch is arranged in the torque flow between the electric machine and the transmission assembly.

17. The drive powertrain of claim 15, wherein the second clutch is arranged in the torque flow between the brake and the transmission assembly.
